(19) United States
(12) Patent Application Publication
(10) Pub. No.: US 2016/0342967 A1
(43) Pub. Date: Nov. 24, 2016

(54) Systems and Methods for Banking Platform Isolation

(71) Applicant: Green Dot Corporation, Pasadena, CA (US)

(72) Inventors: Phil Proctor, Pasadena, CA (US); Calvin Park, Mission Viejo, CA (US); David Gullett, Moorpark, CA (US); Adnan Masood, Pasadena, CA (US)

(73) Assignee: Green Dot Corporation

(21) Appl. No.: 14/718,811

(22) Filed: May 21, 2015

(51) Int. Cl. G06Q 20/10; G06Q 20/40

(52) U.S. Cl. CPC G06Q 20/108; G06Q 20/405

(57) ABSTRACT

Systems and methods for banking platform isolation in accordance with embodiments of the invention are disclosed. In one embodiment, a method for providing banking platform isolation includes obtaining account data using an account servicing server system, where the account data describes consumer accounts, obtaining event feed data using the account servicing server system, where the event feed data includes a set of transaction data for at least one consumer account described in the account data, generating an account transaction database for each consumer account based on the event feed data using the account servicing server system, obtaining request data using the account servicing server system, where the request data includes a request for a service for a consumer account, generating response data based on the request data and the account transaction database using the account servicing server system, and transmitting the response data using the account servicing server system.

### FIELD OF THE INVENTION

The present disclosure relates generally to financial services systems, and relates, more particularly, to facilitating communication with payment processors.

### BACKGROUND

The financial services industry provides a plethora of financial services to consumers for managing their finances and engaging in financial transactions with retailers and service providers. Consumers may hold funds within many different types of accounts at many different types of financial institutions. Consumers may access the funds held in the accounts using many different types of cards, including credit cards, debit cards, gift cards, and other types of cards based on the particular type of account associated with the card. The cards may be issued from financial institutions, such as banks, credit unions, savings & loans, and brokerage institutions.

A payment processor is a company that handles transactions for one or more financial institutions. Many payment processors have connections to various card associations and supply authorization and settlement services to the financial institutions. Several payment processors facilitate the movement of funds between payment processors and financial institutions. Payment processors can verify aspects of proposed transactions. Once the payment processor has received confirmation or denial of the verification, the information can be relayed to the financial institution that can then complete or invalidate the payment transaction accordingly.

### SUMMARY OF THE INVENTION

Systems and methods for banking platform isolation in accordance with embodiments of the invention are disclosed. In one embodiment, a method for providing banking platform isolation includes obtaining account data using an account servicing server system, where the account data describes at least one consumer account, obtaining event feed data using the account servicing server system, where the event feed data includes a set of transaction data for at least one consumer account described in the account data, generating an account transaction database for each consumer account based on the event feed data using the account servicing server system, obtaining request data using the account servicing server system, where the request data includes a request for a service for a consumer account, generating response data based on the request data and the account transaction database using the account servicing server system, and transmitting the response data using the account servicing server system.

In another embodiment of the invention, the event feed data is obtained from a payment processor system.

In an additional embodiment of the invention, the event feed data is obtained from a retailer system.

In yet another additional embodiment of the invention, the response data is transmitted to a client device associated with the consumer account.

In still another additional embodiment of the invention, the transaction data includes transaction amount data describing the requested value of the transaction and authorization data describing if the transaction was authorized.

In yet still another additional embodiment of the invention, the method further includes calculating soft balance data for each consumer account based on the account transaction database using the account servicing server system, identifying when a consumer account has a soft balance exceeding the amount specified in the requested amount data using the account servicing server system, when the soft balance exceeds the requested amount data, generating processor request data including the request data and authorization data including approval data for the transaction using the account servicing server system, and transmitting the processor request data using the account servicing server system.

In yet another embodiment of the invention, the processor request data is transmitted to a payment processor system.

In still another embodiment of the invention, the method further includes placing a hold on a consumer account based on the transaction amount data.

In yet still another embodiment of the invention, the event feed data further includes post-transaction data and the method further includes identifying a piece of transaction data corresponding to the post-transaction data using the account servicing server system and removing the hold on the consumer account based on the post-transaction data using the account servicing server system.

In yet another additional embodiment of the invention, the request data includes a balance status request and the method further includes calculating soft balance data for the consumer account based on the account data and the account transaction database using the account servicing server system and generating the response data based on the soft balance data.

In still another additional embodiment of the invention, the method further includes generating processor request data based on the account data and the request data using the account servicing server system and transmitting the processor request data using the account servicing server system.

In yet still another additional embodiment of the invention, the processor request data is transmitted to a payment processor system.

In yet another embodiment of the invention, the method further includes generating batch processor data using the account servicing server system, wherein the batch processor data includes a set of processor request data and transmitting the batch processor data using the account servicing server system.

In still another embodiment of the invention, the method further includes determining availability data for a payment processor system using the account servicing server system, wherein the availability data described when the payment processor system is available and transmitting the batch processor data when the payment processor is available based on the availability data using the account servicing server system.

In yet still another embodiment of the invention, the processor request data includes withdrawal request data.

In yet another additional embodiment of the invention, the processor request data includes deposit request data.

In still another additional embodiment of the invention, the method further includes obtaining error data including a set of transaction identification data and a set of validated event data using the account servicing server system.

In yet still another embodiment of the invention, the method further includes identifying account transactions in the account transaction database based on the transaction identification data using the account servicing server system and correcting the account transactions based on the validated event data using the account servicing server system.

In yet another additional embodiment of the invention, the account data includes account identification data, each transaction in the event feed data includes processor account identification data, and the method further includes mapping the processor account identification data to the account identification data using the account servicing server system, updating the transaction data for each transaction described in the event feed data using the account servicing server system, and generating the account transaction database based on the updated event feed data using the account servicing server system.

In still another embodiment of the invention, an account servicing server system includes a processor and a memory connected to the processor and storing an account servicing application, wherein the account servicing application directs the processor to obtain account data, where the account data describes at least one consumer account, obtain event feed data, where the event feed data includes a set of transaction data for at least one consumer account described in the account data, generate an account transaction database for each consumer account based on the event feed data, obtain request data, where the request data includes a request for a service for a consumer account, generate response data based on the request data and the account transaction database and transmit the response data.

### BRIEF DESCRIPTION OF THE DRAWINGS

FIG. 1 is a conceptual illustration of an account servicing system in accordance with an embodiment of the invention.

FIG. 2 is a conceptual illustration of an account servicing server system in accordance with an embodiment of the invention.

FIG. 3A is a flow chart illustrating a process for fulfilling a request in accordance with an embodiment of the invention.

FIG. 3B is a flow chart illustrating a process for transmitting batch requests in accordance with an embodiment of the invention.

FIG. 4 is a flow chart illustrating a process for issuing a request to a payment processor system in accordance with an embodiment of the invention.

FIG. 5 is a flow chart illustrating a process for reconciling transaction data in accordance with an embodiment of the invention.

FIGS. 6A-B are flow charts illustrating processes for mapping account data in accordance with an embodiment of the invention.

FIG. 7 is a flow chart illustrating a process for selecting a payment processor system in accordance with an embodiment of the invention.

FIG. 8 is a flow chart illustrating a process for incorporating a payment processor system in accordance with an embodiment of the invention.

### DETAILED DESCRIPTION

Turning now to the drawings, systems and methods for banking platform isolation in accordance with embodiments of the invention are disclosed. Prepaid accounts allow consumer accounts to easily have access to funds that have been deposited to their prepaid account without the overhead of a traditional financial institution. Prepaid cards allow consumers to load funds onto their consumer accounts associated with the prepaid card (i.e. a prepaid card account) at a variety of participating locations, such as retailers. Funds can be loaded onto a prepaid card (i.e. deposited into the consumer account associated with the prepaid card) through various mechanisms, including direct-deposit, check deposit, wire transfers, online deposits, cash deposits, and any other techniques as applicable to the requirements of specific embodiments of the invention. Consumers can then use the prepaid cards in a manner similar to traditional debit and/or credit cards to purchase products using the funds that have been loaded onto the account.

Account servicing systems in accordance with a variety of embodiments of the invention include account servicing server systems that can communicate with consumer systems and isolate those communications from payment processor systems and/or financial institution systems. Consumer systems include point of sale systems, client devices, retailer systems, and any other system that can be utilized to obtain and/or display data regarding a consumer account as appropriate to the requirements of specific applications of embodiments of the invention. Account servicing systems can abstract and isolate payment processor systems and/or financial institution systems from the account servicing server system utilizing a banking platform interface. The banking platform interface can allow an account servicing server system to seamlessly communicate with multiple payment processor systems and/or financial institution systems by translating internal command data to payment processor system (and/or financial institution system) command data. The banking platform interface allows for the dynamic routing of communication between consumer systems, account servicing server systems, and payment processor systems and/or financial institution systems. Additionally, the account servicing system can then automatically prepare (and/or translate) data provided as part of the services to command data that is utilized by payment processor systems to execute the requested services. In a variety of embodiments, a payment processor system identifies a consumer account using processor account identifier data. The same consumer account can also be identified by an account servicing server system using account identifier data. Using the banking platform interface, the account servicing server system can dynamically map account identifier data and processor account identifier data in order to identify particular consumer accounts.

Similarly, the communication between consumer systems and payment processor systems and/or financial instruction systems can be abstracted in order to decouple requests for transaction data from the processing of transaction data. In this way, a variety of services can be provided by an account servicing system to consumer systems. In a variety of embodiments, account servicing server systems obtain data from payment processor systems and store the payment processor data. Payment processor data can include, but is not limited to, account data, processor request data, and/or processor transaction data. The stored data can then be utilized to provide services to consumer systems. Additionally, reconciliation data can be obtained and utilized to verify the accuracy of the stored data and/or verify the authenticity of transaction data received (or not received) from the payment processor systems. Any data, including summarized transaction data received from a payment processor system, can be utilized as reconciliation data as appropriate to the requirements of specific applications of embodiments of the invention. Furthermore, the stored data can be utilized to pre-authorize transactions or other actions as appropriate to the requirements of specific applications of embodiments of the invention, including those described below.

In many embodiments, account servicing systems can detect account activity and target advertising to client devices associated with the active accounts based on location information associated with or implied by the account transactions (e.g. the location of a point of sale) and/or available account balances. In this way, the account servicing systems allow advertisers to programmatically target advertisements based on the location of a consumer and the funds available to the consumer account (i.e. the pre-paid card account associated with the consumer). In several embodiments, the account servicing systems directly target advertising to consumer accounts and/or client devices associated with consumer accounts. In a number of embodiments, the account servicing systems provide account identification data identifying consumer accounts and/or client devices associated with consumer accounts as targets to advertising networks that target advertisements to the identified consumer accounts. In accordance with the requirements of specific applications of embodiments of the invention, advertising data includes one or more offers than can be redeemed by a consumer account. Offers can include, but are not limited to, offers that can be redeemed to obtain a discount on particular goods and/or result in a credit to the consumer account's account. In a variety of embodiments, advertising data includes a set of offers, where an offer includes a mapping between a particular product and a discount to be applied to the purchase of that product. That is, advertising data can include a set of mappings between product data describing products and offer data describing offers applicable to the products. Account servicing systems can analyze a consumer account's financial transactions and apply offers to the consumer account's account and/or transactions based on transactions that satisfy the criteria of previously presented (and/or accepted) offers presented to the consumer account. In this way, account servicing systems can facilitate the redemption of offers associated with advertising presented to consumer accounts, thereby encouraging consumer accounts to shop at particular retailers. The account servicing server systems can utilize stored payment processor data to determine the status of a consumer account and provide an authorization (i.e. a soft authorization) for a loan and/or account credit. The account servicing server systems can issue requests to payment processor systems based on the stored payment processor data to authorize a particular transaction. In a number of embodiments, the consumer account can be notified at the time a purchase is being made that a particular offer (e.g. coupon) is being applied to a transaction. For example, if the regular price of an item is $100, and a consumer account had previously received an offer for 25% off the particular item, then at the time of check-out the consumer account can obtain the 25% discount and pay only $75. In this way, the consumer account's account is debited by $75. By way of another example, the consumer account can initially pay the $100 for the particular item and then their account could be reimbursed for the 25% savings. In this way, the consumer account's account is debited for $100 and a $25 credit is contributed to the consumer account's account. In a variety of embodiments, account servicing server systems instruct payment processor systems to provide a temporary credit in the amount of the specific offer being applied in order to authorize a particular transaction, particularly those transactions where the consumer account's account does not have sufficient funds to fulfill the transaction in the absence of the credit to be applied to the account. In many embodiments, client devices can receive and/or display notifications of the rewards available and/or applied to particular transactions. Systems and methods for targeting advertising that can be utilized in accordance with embodiments of the invention are described in U.S. patent application Ser. No. 14/587,945, titled “Systems and Methods for Targeting Advertising to Prepaid Card Accounts” and filed Dec. 31, 2014.

In several embodiments, account servicing server systems allow consumer accounts to identify particular goods that they wish to purchase. In many embodiments, the account servicing server systems facilitate the establishment of savings accounts for each of the identified goods. Funds that are loaded onto a prepaid card can then be allocated, either manually or automatically, to the savings account for a particular good. When a consumer account uses the prepaid card to purchase the identified good, the funds to purchase the good can then be taken from the savings account for that good. Account servicing systems can utilize a variety of data such as, but not limited to, demographic information regarding the consumer account, the prepaid card, and/or the identified goods, to provide targeting information to a variety of retailers and/or advertisers. In a variety of embodiments, the targeting information is utilized to target advertising to particular consumer accounts. Additionally, the advertising data can be displayed based on the reload activity associated with the prepaid card. For example, advertising data related to a particular good that is sold at a retailer can be displayed when the consumer account loads funds onto a prepaid card using a terminal at the retailer. By providing a consumer account with an advertisement and/or coupon, account servicing server systems can provide the consumer account with an offer at an opportune time that is particularly useful to the consumer account. Systems and methods for identifying future purchases and targeting advertising data that can be utilized in accordance with embodiments of the invention are described in U.S. patent application Ser. No. 14/587,931, titled “Systems and Methods for Targeting Advertising Based on Future Purchases” and filed Dec. 31, 2014.

In a number of embodiments, account servicing systems can automatically determine fraud in transactions along with potentially extending loans to particular prepaid card account. By extending a loan to these consumer accounts, prepaid cards can be utilized to complete these transactions even when insufficient funds are present. Any of a variety of loans can be extended in accordance with the requirements of specific applications of the invention including, but not limited to, unsecured loans, secured loans, and installment (e.g. closed-ended) loans. The particular loan product(s) extended to a consumer account can depend on any of a variety of factors such as, but not limited to, the amount of the loan offered, the amount of security associated with the consumer account, the recency of the last loan offered, accepted, and/or paid off by the consumer account, the amount of loans previously offered and/or outstanding, the products being purchased, demographic information describing the consumer account, the balance history of the account, and any other data as appropriate to the requirements of specific applications of embodiments of the invention. In particular, loans can be offered when prepaid cards are utilized to purchase goods at both brick and mortar retail locations and online marketplaces. Furthermore, multiple payment methods can be utilized in a single transaction. Payment methods include cash, check, prepaid card, loan (e.g. credit), and any other payment method as appropriate to the requirements of specific applications of embodiments of the invention. Systems and methods for determining fraud and/or loan underwriting and for transmitting request data and/or authorization data to payment processor systems that can be utilized in accordance with embodiments of the invention are described in U.S. patent application Ser. No. 14/699,753, titled “Systems and Methods for Loan Underwriting for Prepaid Accounts” and filed Apr. 29, 2015.

The disclosures of U.S. patent application Ser. Nos. 14/587,945, 14/587,931, and 14/699,753 are hereby incorporated by reference in their entirety. Systems and processes for banking platform isolation in accordance with embodiments of the invention are described in more detail below.

### Account Servicing Systems

Conducting financial transactions can involve communication between many different parties (e.g., banks, processors, credit issuers, regulators, consumers, etc. . . . ) prior to funds being exchanged between a consumer and a retailer (i.e. between a consumer account and the retailer's account). For example, a consumer account may initiate a purchase at a point-of-sale terminal of a retailer. The retailer system may track certain information for the consumer account, including the items being purchased and the total purchase price and may send this information to a payment processor system. In turn, the payment processor system can communicate with a multitude of financial institution systems in order to process the transaction. An account servicing server system can obtain transaction data from the retailer system, the payment processor system, client devices, and/or financial institution systems. The transaction data can be utilized to perform a variety of activities, such as but not limited to reconciling the consumer account, providing services related to the consumer account, and/or determining potential fraud related to the consumer account as described in more detail below.

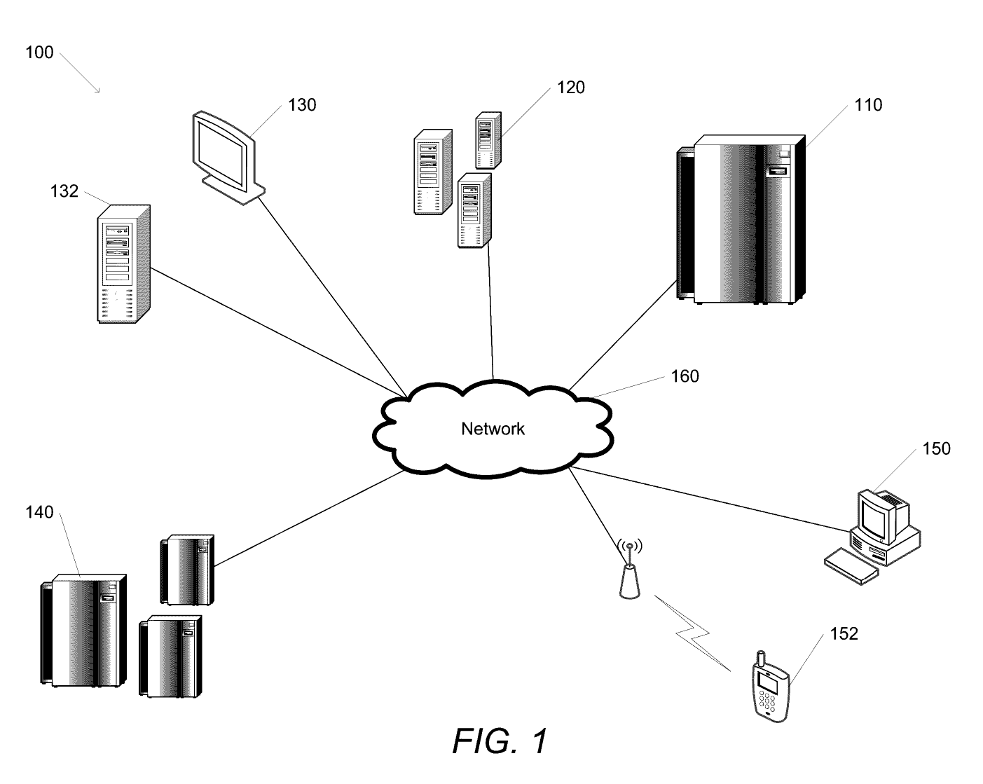

Turning now to FIG. 1, a conceptual illustration of an account servicing system in accordance with an embodiment of the invention is shown. The account servicing system 100 includes account processing server system 110, payment processor systems 120, retailer systems such as point of sale terminals 130 and retailer server system 132, financial institution systems 140, and client devices including, but not limited to, personal computers 150 and mobile devices 152. These systems communicate through one or more networks 160. Network(s) 160 can include, but are not limited to, the Internet, a local area network, a wide area network, and networks that are shared privately between only a subset of the systems. For example, the payment processor 120 can communicate with the financial institution systems 140, retailer systems, and account servicing server system 110 via one or more private networks.

Account servicing server system 110 can provide front-end and back-end services for creating and managing consumer accounts for prepaid cards via a number of account servicing processes as appropriate to the requirements of specific applications of embodiments of the invention. Account servicing server system 110 can obtain account data for a prepaid card from a retailer system and/or from a client device. The account servicing server system 110 can assign the consumer account to a payment processor system 120 and/or financial institution system 140. A request that a permanent card be issued to the account holder associated with the account by the payment processor system 120 and/or financial institution system 140 can also be made. The account servicing server system 110 can also communicate with financial institution systems 140 and/or the payment processor systems 120 to facilitate the execution of transactions between consumer accounts and retailer systems when the transaction involves the prepaid card. This can include storing a variety of data obtained from the payment processor systems 120, financial institution systems 140, and/or retailer systems and using the stored data to provide account servicing processes. In many embodiments, the account servicing server system 110 includes some or all of the aspects of the payment processor systems 120 and/or the financial institution systems 140. In a number of embodiments, the retailer systems host their own account servicing server system 110.

The account servicing server system 110 can also provide an interface providing account data, user profile data, balance data, transaction data, fee data, and any other data related to the prepaid card and/or the consumer account as appropriate to the requirements of specific applications of embodiments of the invention. In many embodiments, the consumer account is provided funds (cash, check, direct deposit, etc. . . . ) from a point of sale terminal at a retailer along with a prepaid card. The retailer system can then transmit transaction data specifying the amount of funds to be added to the consumer account associated with the prepaid card to an account servicing server system, a payment processor system, and/or a financial institution system as appropriate to the requirements of specific applications of embodiments of the invention. If necessary, the account servicing server system 110 can provide a mapping between account identification data identifying the consumer account and processor account identification data. When a transaction is executed, the account servicing server system 110 can obtain event feed data describing the transaction, including the amount to be debited as a result of the transaction and/or the status (i.e. approved, denied) of the transaction. By way of example, processor request data (i.e. transaction data) can be transmitted to a payment processor system associated with the prepaid card. The payment processor system determines that insufficient funds are present in the consumer account and denies the transaction. The payment processor system can then notify the account servicing server system that a transaction has been presented and denied. In this way, the account servicing server system 110 can facilitate the purchase of products using a prepaid card by automatically granting loans in order to facilitate a transaction. In several embodiments, the account servicing server system provides pre-authorization data to the payment processor system so that the transaction is not denied.

Retailer systems, such as point of sale terminal 130, can be used to purchase prepaid cards, load fund onto the prepaid cards, as well as process transactions that use a prepaid card associated with a consumer account to make purchases of products and/or services from the retailer. The point of sale terminal 130 can transmit transaction data describing the requested transaction to the retailer server system 132 and/or the processor system 120. In many embodiments, the point of sale terminal 130 communicates directly with the account servicing server system 110. In a variety of embodiments, the retailer server system 132 obtains transaction data from a number of point of sale terminals 130 and transmits the transaction data utilizing techniques similar to those described above. In many embodiments, the account servicing server system 110 stores data obtained from the retailer systems and/or associates the obtained data with particular consumer accounts.

Payment processor systems 120 can process transactions on behalf of financial institution 140, retailer systems, card issuers, and many other types of financial institutions. In many embodiments, prepaid cards serviced by the account servicing server system 110 are associated with a particular payment processor system 120. In a variety of embodiments, the payment processor system 120 issues the prepaid cards for a particular consumer account. Payment processor systems 120 provide a transaction interface that can be utilized to process transaction data. The transaction data can be obtained from any system, including the retailer system. The payment processor system can process data in real-time, on a set schedule, and/or in batch as appropriate to the requirements of specific applications of embodiments of the invention. In a number of embodiments, the payment processor system 120 processes transactions for prepaid cards (or any other account) issued by (or otherwise associated with) the payment processor system 120. In a variety of embodiments, the payment processor system 120 provides a bill payment service between one or more consumer accounts. Processing transaction data includes determining if a transaction should be authorized. In several embodiments, the transaction data includes transaction amount data describing the requested value of the transaction. Authorizing a transaction can include determining if the requested value is less than the balance of the consumer account. If a transaction is authorized, funds drawn from an account associated with the prepaid card are directed to be transferred to an account associated with the retailer identified in the transaction. The transfer of funds can include transmitting requests to one or more financial institution systems 140 and/or the account servicing server system 110 in order to execute the requested transaction. In several embodiments, if the transaction is not authorized, the payment processor system 120 can request additional information from the account servicing server system 110. This additional information can then be utilized to re-process the transaction, potentially resulting in the transaction being authorized. In a variety of embodiments, payment processor systems 120 provide one or more account servicing interfaces to communicate with the account servicing server system 110 and/or financial institution system 140. The account servicing interface can be utilized by the account servicing server system 110 to obtain and/or transmit data to and from the payment processor system 120. For example, if the payment processor system 120 needs additional information in order to process a transaction, that information can be requested and obtained from the account servicing server system 110 and/or the financial institution system 140. However, it should be noted that any processes that include communication between the payment processor system 120 and other systems within the account servicing system 100 can utilize the account servicing interface as appropriate to the requirements of specific embodiments of the invention.

Financial institution systems 140 include financial accounts for one or more entities. These financial accounts hold funds on behalf of the entities and can transfer the funds to retailer systems, payment processors, account servicing server systems, or any other system as appropriate to the requirements of specific applications of embodiments of the invention. In many embodiments, financial institution systems 140 incorporate some or all aspects of the payment processor systems 120. In this way, financial institution systems can issue, service, and/or approve transactions for consumer accounts related to prepaid cards.

Client devices can be used to manage account data associated with prepaid cards, purchase cards, add (e.g. reload) or remove funds from cards, purchase products from a retailer, request and/or accept loans, and any other transactions or operations as appropriate to the requirements of specific applications of embodiments of the invention. Furthermore, client devices can be utilized to request loans for particular consumer accounts. The account servicing server systems 110 can provide account data, balance data, transaction data, and/or any other appropriate data to the client devices based on processor request data and/or processor transaction data stored using the account servicing server system. In this way, the data and services provided to the client devices can be isolated from the payment processor systems facilitating the services. This can allow for consumer accounts to be easily migrated from one payment processor system to another. Furthermore, additional consumer accounts associated with an outside payment processor system can be efficiently incorporated by providing a facility for incorporating the outside payment processor system into the set of payment processor systems associated with the account servicing server system. In this way, the additional consumer accounts can benefit from the services and data provided by the account servicing server system by way of consumer devices associated with the additional consumer accounts.

Although a specific architecture of an account servicing system in accordance with embodiments of the invention are discussed above and illustrated in FIG. 1, a variety of architectures, including client devices not specifically named and account servicing server systems that incorporate aspects of payment processor systems and/or financial institution systems, can be utilized in accordance with embodiments of the invention. Furthermore, it should be noted that any data created and/or transferred within the system can be provided by any system in any manner (i.e. via one or more application programming interfaces (APIs) web services, and/or file-based interfaces) as appropriate to the requirements of specific applications of embodiments of the invention.

### Account Servicing Server Systems

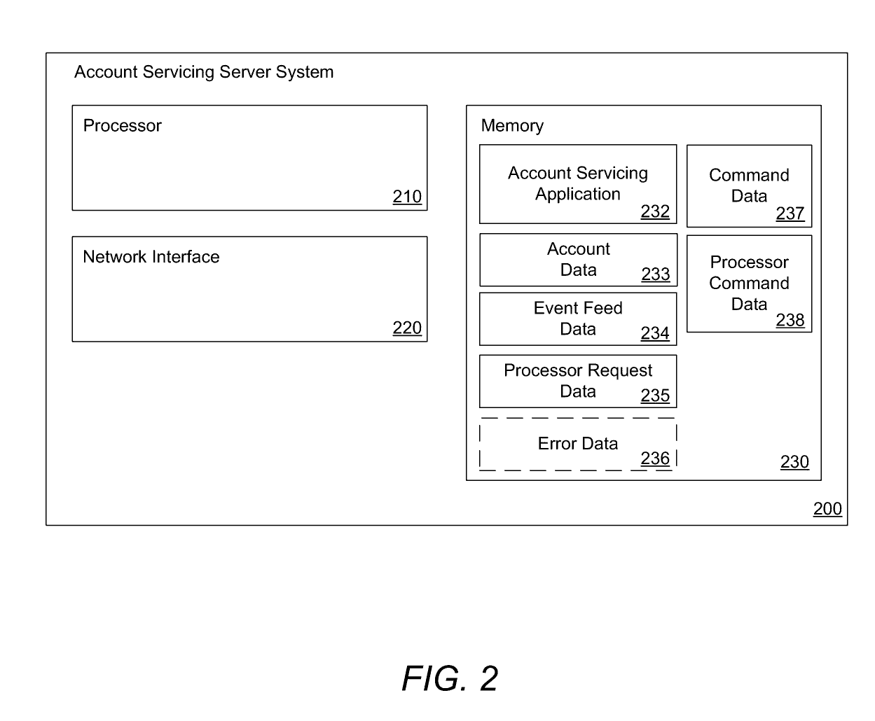

As described above, account servicing server systems can provide a variety of services for consumer accounts associated with prepaid cards. Additionally, account servicing server systems can provide these services by maintaining an account transaction database of account data and providing the services based on the account data. The account servicing server systems can further provide data to payment processor systems to facilitate the services and obtain a variety of data from the payment processor systems that can be used to update and validate the account data. An account servicing server system in accordance with an embodiment of the invention is conceptually illustrated in FIG. 2. The account servicing server system 200 includes a processor 210 in communication with a network interface 220 and a memory 230. The network interface 220 is configured to send and receive data over a network connection. In a number of embodiments, the network interface 220 is in communication with the memory 230. In several embodiments, memory 230 is any form of storage configured to store a variety of data, including, but not limited to, an account servicing application 232, account data 233, event feed data 234, processor request data 235, command data 237, processor command data 238, and, in many embodiments, processor transaction data 236.

The account servicing application directs the processor 210 to perform a variety of account servicing processes. The account servicing processes include processing financial transactions for a consumer account, including reconciliation of debits and credits applied to a consumer account. The account servicing processes can also include managing account data 233 describing the consumer account including, but not limited to, reload activity, balance activity, and location data, consumer account profile data, demographic data, employment information, credit status, income, mailing address, and/or any other consumer account pertinent information. Account data 233 can include data received from a variety of different sources, including client devices, retailer systems, payment processor systems, financial institution systems, and any other of a variety of other sources.

Furthermore, the account data 233 can be related to event feed data 234, processor request data 235 and/or error data 236. Processor request data 235 includes any data related to a service provided by an account servicing server system, such as product data, account data, retailer system data, and location data. In many embodiments, product data can include a variety of category data describing the category associated with a target product and/or a set of attribute/value pairs that describe the product. Error data 236 can include purchase history, credits and deposits, available balance, retailer data, transaction data, and any other information as appropriate to the requirements of specific applications of the invention. Event feed data can include any data, such as processor request data and/or error data, that is obtained from a payment processor system and describes particular transactions that have been conducted using the payment processor system. Command data 237 includes a variety of commands utilized in account servicing processes to provide a variety of services to consumer accounts and/or client devices. These commands can include opening a consumer account, closing a consumer account, transferring funds to a consumer account, deducting funds from a consumer account, depositing funds to a consumer account (i.e. a reload transaction), and any other command as appropriate to the requirements of specific applications of embodiments of the invention. Processor command data 238 includes a variety of processor commands that can be transmitted to and/or received from a payment processor system. These processor commands can include any of the commands described above along with any other payment processor system-specific commands as appropriate to the requirements of specific applications of embodiments of the invention. A variety of account servicing processes include mapping command data 237 to processor command data 238 and vice versa.

In many embodiments, account identification data is associated with a piece of command data. Similarly, processor account identification data can be associated with a piece of processor command data, processor request data, and/or error data. As is described in more detail below, account servicing processes can include mapping account identification data to and/or from processor account identification data in order to provide a variety of services to the consumer account identified by the account identification data and processor account identification data. As is described in more detail below, the mapping of identification data and/or command data can allow for migrating consumer accounts and/or incorporating additional payment processors utilizing a variety of account servicing processes.

Although a specific architecture for an account servicing server system in accordance with an embodiment of the invention is conceptually illustrated in FIG. 2, any of a variety of architectures, including those that store data or applications on disk or some other form of storage and are loaded into memory at runtime, can also be utilized. In a variety of embodiments, the memory 230 includes circuitry such as, but not limited to, memory cells constructed using transistors, that are configured to store instructions. Similarly, the processor 210 can include logic gates formed from transistors (or any other device) that are configured to dynamically perform actions based on the instructions stored in the memory. In several embodiments, the instructions are embodied in a configuration of logic gates within the processor to implement and/or perform actions described by the instructions. In this way, the systems and methods described herein can be performed utilizing both general-purpose computing hardware and by single-purpose devices. A variety of account servicing processes in accordance with embodiments of the invention are discussed further below.

### Fulfilling Requests

Account servicing processes can include receiving requests for services from client devices and fulfilling those services. In a variety of embodiments, account servicing processes include obtaining and caching a variety of data from one or more payment processor systems. The cached event feed data can then be used to provide services and/or provide temporary authorizations for services while the underlying payment processor systems execute transactions to perform the service. In several embodiments, payment processor systems provide event feed data. Event feed data can include data describing transactions for one or more accounts, location data regarding where the transactions occurred, authorization data describing if a particular transaction was authorized, balance data for one or more consumer accounts, transaction identification data, and/or any other data, such as shopping cart data describing the items that are subject to the transaction, as appropriate to the requirements of specific applications of embodiments of the invention. In this way, the cached event feed data can be utilized to provide a variety of account information and services to client devices and/or transmit requests to payment processor systems to fulfill the requested services.

The use of the cached event feed data and/or account data can allow for a variety of services to be provided by the account servicing server system without engaging a payment processor system. In a number of embodiments, the cached event feed data is utilized to maintain soft balance data for a particular consumer account. As event feed data is obtained, the soft balance data can be updated. This can allow the account servicing server system to provide accurate balance data to client devices before any services are requested by the client device. For example, if several transactions have been executed on a consumer account and the balance of the consumer account falls below a threshold value, a notification can be provided to the client device indicating that the account balance is low. Similarly, a variety of transactions can be pre-emptively allowed (or denied) based on the soft balance without incurring a rejection by the payment processor system. Techniques for facilitating transactions based on the soft balance data that can be utilized as appropriate to the requirements of specific applications of embodiments of the invention are described in U.S. patent application Ser. Nos. 14/587,945 and 14/587,931, incorporated by reference above. In many embodiments, including those described in more detail below, a fee is associated with obtaining data from or transmitting data to a payment processor system. The use of the cached event feed data can lessen the load on the payment processing systems and potentially avoid fees associated with obtaining data from the payment processor systems to execute some or all services to client devices.

A variety of payment processor activity can be described in the event feed data. First, transaction data identifying a consumer account and having unique identification data can be described. The transaction data can include authorization data describing if the transaction was authorized or declined. Based on the authorization data, the soft balance data for a particular consumer account can be updated by placing a hold on the consumer account in view of the approval of the transaction for the amount specified in the transaction. In several embodiments, if a transaction is flagged as denied, the soft balance is not updated. A second type of data is post-transaction data. After the transaction described in the transaction data is executed, post-transaction data including the transaction identification data and the actual transaction amount data. Once the post-transaction data is obtained, the hold on the consumer account is removed and the amount of funds indicated in the post-transaction data can be removed from the consumer account. In several embodiments, the transaction data includes authorization timeout data describing how long the hold should be held on the consumer account. In a variety of embodiments, if post-transaction data corresponding to the transaction data is not received within the authorization timeout period, the hold is removed from the consumer account and no funds are deducted. In many embodiments, when the authorization timeout period is exceeded, the hold is automatically applied to the consumer account as an authorized transaction and the specified funds are deducted from the consumer account. The behavior of the transaction data and/or the post-transaction data can be payment processor system specific as appropriate to the requirements of specific applications of embodiments of the invention. Third, balance data can be obtained in the event feed data. The balance data identifies a consumer account and the current balance of the consumer account. The balance data can be mapped to account data utilizing techniques such as those described below.

The event feed data can be obtained on a per-transaction basis and/or as batch transaction data received at one or more times during the day as appropriate to the requirements of specific applications of embodiments of the invention. The event feed data can then be processed and stored (i.e. cached) using the account payment processor system using any of a variety of storage devices, such as a database, an in-memory model, file-based storage, or any other storage techniques. Account servicing processes can include processing the event feed data and storing the processed event feed data. This processing can include identifying particular consumer accounts based on processor account identification data as described in more detail below.

Event feed data can be obtained from and/or processor request data can be transmitted to payment processor system in real-time and/or on a schedule as appropriate to the requirements of specific applications of embodiments of the invention. In a variety of embodiments, when processor request data is transmitted to a payment processor system at a specific time, a variety of pieces of processor request data are combined together into batch processor data and the batch processor data is transmitted to the payment processor system. Similarly, batch processor data can be generated when a payment processor system is unavailable and transmitted to a payment processor system when the payment processor system becomes available. It should also be noted that any requests sent to payment processor systems can be retryable. If a particular request is not retryable, it can be excluded from later processing and/or being added to a set of batch processor data as appropriate to the requirements of specific applications of embodiments of the invention.

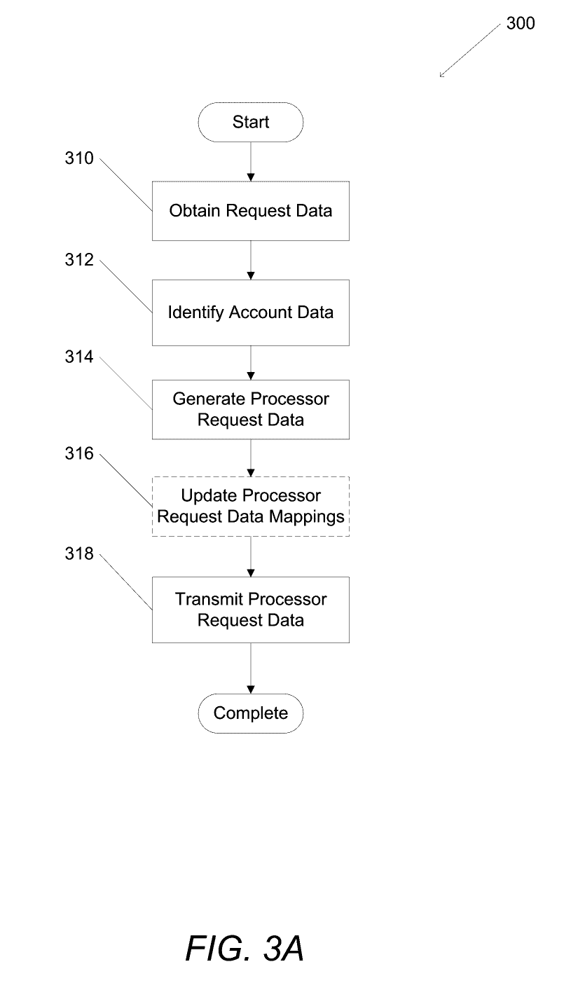

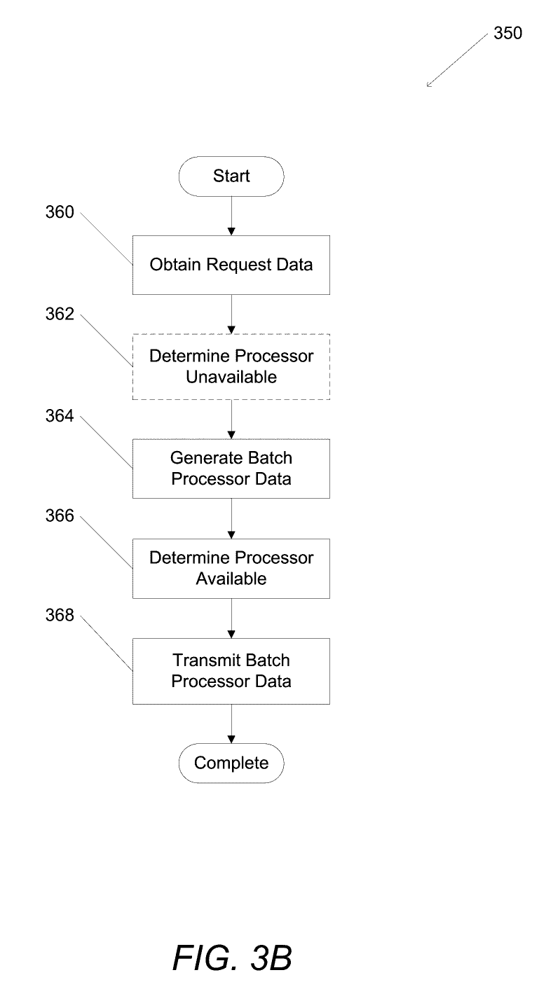

A process for fulfilling requests in accordance with embodiments of the invention is shown in FIG. 3A. The process 300 includes obtaining (310) request data, identifying (312) account data, locating (314) processor transaction data, and generating processor request data. In a variety of embodiments, processor request data mappings are updated (316). Processor request data is transmitted.

Turning now to FIG. 3B, a process for fulfilling batch requests is shown. The process 350 includes obtaining (360) request data and, in a variety of embodiments, determining (362) that a payment processor system is unavailable. Batch processor data is generated (364), processor availability is determined (366) and batch processor data is transmitted (368).

Specific processes for fulfilling requests in accordance with embodiments of the invention are described above; however, any of a variety of processes, including those with payment processor systems providing data other than that described above, can be utilized as appropriate to the requirements of specific applications in accordance with embodiments of the invention.

### Issuing Requests to Payment Processors

As described above, a variety of requests can be transmitted to payment processor systems in order to execute services provided by an account servicing server system. One account servicing process can include executing load requests. In many embodiments, load request data include account identification data, value data describing the funds to be added to the consumer account identified by the account identification data, and/or location data describing where the load was requested. Appropriate processor request data can be created and the processor request data can be transmitted to the appropriate payment processor system. If the payment processor system is down or unavailable, account servicing processes can include allowing the transaction to proceed based on the soft balance of the consumer account utilizing processes similar to those described above.

A second account servicing process can include transferring funds between consumer accounts. In a variety of embodiments, a transfer is performed by creating withdrawal request data for the first consumer account and deposit request data for the second consumer account. Both withdrawal request data and deposit request data can include account identification data and fund transfer data, where the account identification data identified the consumer account and the fund transfer data described the amount of funds to add (or withdraw) from the consumer account. In several embodiments, consumer score data is associated with a consumer account. Consumer accounts having consumer score data above a particular threshold can be identified as “good” consumer accounts, while consumer accounts having consumer score data below a particular threshold can be identified as “bad” consumer accounts. If a consumer account is indicated as “good,” the deposit request data can be processed before the withdrawal request data is completed, thereby allowing the consumer account to access the funds before they are deposited into the consumer account. Likewise, if a consumer account is indicated as “bad,” the deposit request data can wait to be processed until after the withdrawal request data has been executed.

A third account servicing process can include performing bill payments to a financial institution (or other third-party system) on behalf of a consumer account. The bill payment can be performed based on the actual account balance and/or the soft account balance as appropriate to a specific consumer account. The bill payment process can include generating withdrawal request data for the consumer account and deposit request data for the third-party system. If both the third-party system and the consumer account have their accounts with the account servicing server system, both the withdrawal request data and the deposit request data can be executed automatically against the soft balances for each account.

A fourth account servicing process can include updating data associated with a consumer account. Client devices can provide account change request data to an account servicing server system. Any of a variety of profile and/or demographic data, such as address data, can be described in the account change request data and updated as appropriate to the requirements of specific application of embodiments of the invention. In a number of embodiments, some or all of the account data (or the changes to the account data) can be used to dynamically determine the payment processor for a particular account. For example, if a consumer account is associated with payment processor A while located in New York, N.Y. and an address change is received to change the location of the consumer account to Los Angeles, Calif., the consumer account could be migrated from payment processor A to payment processor B. This can be done for any of a variety of reasons as appropriate to the requirements of specific applications of embodiments of the invention, such as payment processor B charging more favorable rates for consumer accounts located on the west coast than payment processor A. In several embodiments, account change request data can be transmitted to payment processor systems and/or financial institution server systems. In a variety of embodiments, the consumer account profile data can be utilized to authorize (or otherwise retry) transactions that have been denied. For example, a piece of processor transaction data can indicate the zip code associated with the consumer account and the processor transaction data is indicated as denied because the zip code does not match the zip code on record with the payment processor system. However, account change request data has been submitted to the account servicing server system with the correct zip code. When the account servicing server system obtains the processor transaction data with the denied transaction, the provided zip code can be compared to the zip code associated with the consumer account. If the zip codes match, processor request data can be generated to execute the denied transaction with the updated zip code. It should be noted that any account servicing processes including profile data and/or demographic data can be performed as appropriate to the requirements of specific applications of embodiments of the invention.

In a number of embodiments, priority data can be associated with any of the requests. For example, load request data can be higher priority than deposit request data which can be higher than withdrawal request data which can be more important than account change request data. However, any priority can be utilized as appropriate to the requirements of specific applications of embodiments of the invention.

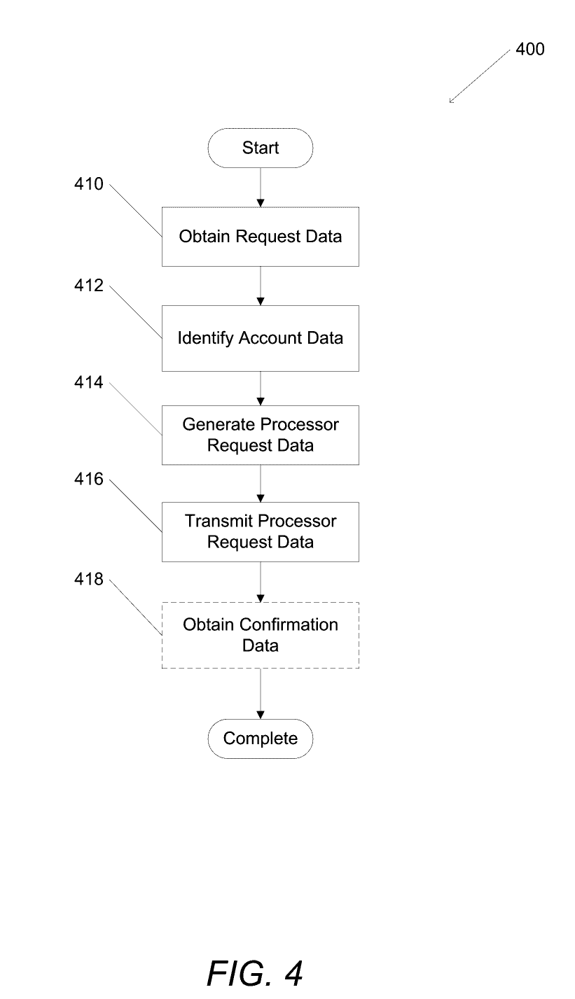

A process for issuing a request to a payment process in accordance with embodiments of the invention is shown in FIG. 4. The process 400 includes obtaining (410) request data, identifying (412) account data, generating (414) processor request data, and transmitting (416) processor request data. In a number of embodiments, confirmation data is obtained (418).

Process for issuing requests in accordance with embodiments of the invention are described above. However, any of a variety of processes, including those that issue requests using techniques other than those specifically described above, can be utilized as appropriate to the requirements of specific applications in accordance with embodiments of the invention.

### Reconciling Transaction Data

As described above, errors and/or changes can occur in transaction data provided to and/or from a payment processor system. In a variety of embodiments, payment processor systems provide error data one or more times per day, although the error data can be provided at any time as appropriate to the requirements of specific applications of embodiments of the invention. The error data can include data similar to that described above with respect to the event feed data; the error data describes validated event feed data. The error data can include a full copy of the relevant pieces of event feed data (subject to any differences due to validations and/or corrections that occurred to the event feed data) and/or only the subset of event feed data that has changed as appropriate to the requirements of specific applications of embodiments of the invention. Account servicing processes can include processing the error data and updating the locally stored data to account for any changes in the event feed data. Account servicing processes can include processing the error data according to a set of reconciliation rule data. A variety of errors can be identified using the error data as appropriate to the requirements of specific applications of embodiments of the invention, including missing transactions, amount (transaction and/or account) discrepancies, and account number errors. In many embodiments, a proper reconciliation rule does not exist and account servicing processes include flagging pieces of error data that cannot be processed and/or need additional review from a human expert.

In several embodiments, the error data can trigger fraud detection processes, such as those described in U.S. patent application Ser. No. 14/699,753, incorporate by reference above. A variety of criteria can be utilized to identify potential fraud in the event feed data and/or the error data, such as the command data (i.e. the transaction to be performed) failing to have corresponding command data or processor command data. However, it should be noted that any of a variety of criteria can be utilized in the fraud detection processes as appropriate to the requirements of specific applications of embodiments of the invention.

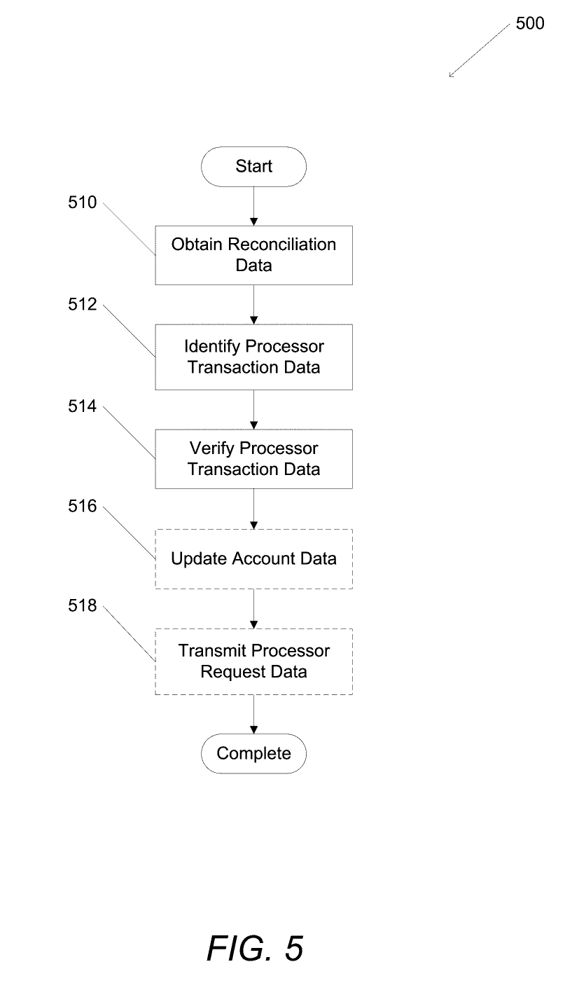

A process for reconciling transaction data in accordance with embodiments of the invention is shown in FIG. 5. The process 500 includes obtaining (510) reconciliation data, identifying (512) processor transaction data, verifying (514) processor transaction data. In several embodiments, account data is updated (516) and/or processor request data is transmitted (518). Specific processes for reconciling transaction data in accordance with embodiments of the invention are described above; however, any of a variety of processes, including those that reconcile the event feed data utilizing techniques other than those specifically described above, can also be utilized as appropriate to the requirements of specific applications in accordance with embodiments of the invention.

### Mapping Account Data

As described above, a variety of account servicing processes include mapping processor identification data provided by a payment processor and/or account identification data utilized by an account servicing server system to a specific consumer account. A variety of identifiers can be used to identify a particular consumer account, including card number data, and account identification data, processor account identification data. Any other identification data can be utilized as appropriate to the requirements of specific applications of embodiments of the invention. In several embodiments, account servicing processes include modifying processor request data being transmitted to a payment processor system to replace account identification data with processor account identification data for a particular consumer account. In this way, the identification used by the payment processor systems can be protected from potential security breaches in account servicing server systems as the processor account identification data is not utilized in the generation of the processor request data. In a number of embodiments, a number of pieces of processor account identification data can be associated with a particular consumer account. In this way, the appropriate processor account identification data can be substituted depending on which payment processor system receives the processor request data. Additionally, the mapping of processor account identification data to account identification data can allow activity associated with a particular consumer account to be tracked across multiple payment processor systems. Similarly, the account identification data allows consumer accounts to be easily moved between payment processor systems.

Account servicing processes can also include initiating consumer accounts and assigning card number data to a consumer account. In the event that a payment processor system is unavailable or a physical card is not available, account identification data can be created for the consumer account and any fund load activity can be performed using the account servicing server system. The account servicing server system can then queue up the account creation data and transmit the appropriate requests to a payment processor system once one becomes available. In this way, account servicing server systems can utilize the locally stored data to initiate consumer accounts and process transactions in the absence of a payment processor utilizing techniques similar to those described above.

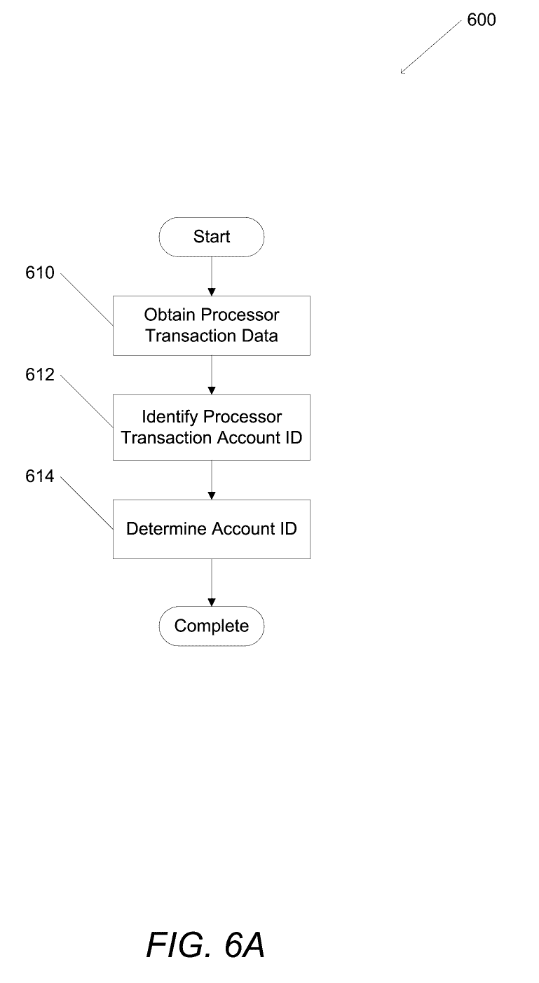

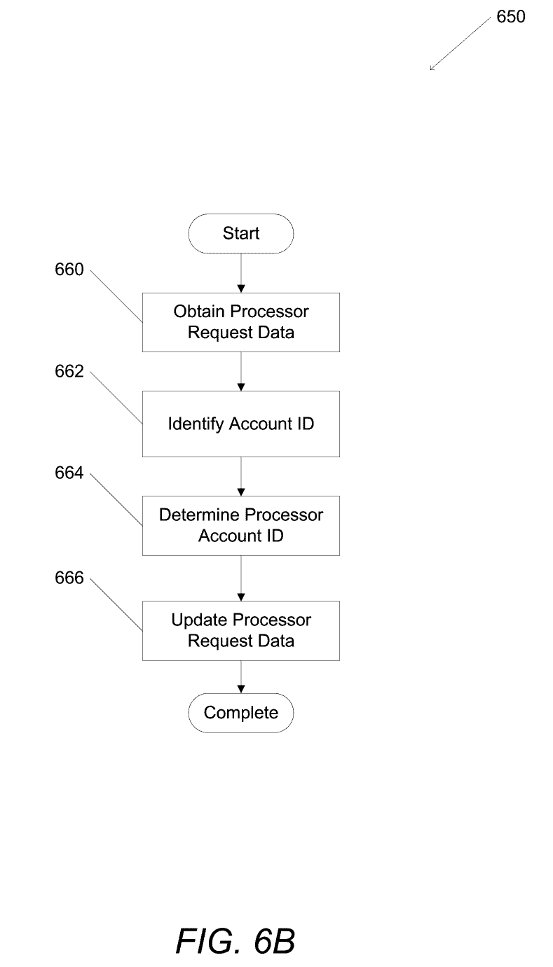

A process for mapping account data in accordance with embodiments of the invention is shown in FIG. 6A. The process 600 includes obtaining (610) processor transaction data, identifying (612) processor transaction account Identification data, and determining (614) account Identification data. Turning now to FIG. 6B, an alternative process for mapping account data is shown. The process 650 includes obtaining (660) processor request data, identifying (662) account Identification data, determining (664) processor account Identification data, and updating (666) processor request data.

Although specific processes for mapping account data in accordance with embodiments of the invention are described above, any of a variety of processes, including but not limited to those embodiments that utilize mapping techniques not specifically described above, can be used as appropriate to the requirements of specific applications in accordance with embodiments of the invention.

### Selecting Payment Processor Systems

As described above, account servicing processes can include determining a payment processor system to execute a particular transaction. A variety of factors can be utilized in determining a particular payment processor system. In many embodiments, a payment processor charges a fee for executing a transaction (i.e. receiving processor request data) and/or providing processor transaction data. One factor that can be utilized is the fee associated with utilizing a particular payment processor system. A second factor that can be utilized is the availability of a payment processor system. A payment processor system can be unavailable for a variety of reasons, including scheduled downtime, service outages, and high load. Account processing server systems can obtain payment processor system load data and utilize the payment processor system load data in determining a payment processor system to receive processor transaction data. However, the data stored using the account servicing server system can be inaccurate or outdated and/or the account servicing server system may be unable to provide a particular service at a particular time. If necessary, the account servicing server system can bypass the stored data and transmit data directly to payment processor systems. In this way, the processing needs associated with providing services to a variety of client devices can be balanced between the capabilities of the account servicing server system and the cost associated with having the services provided by the payment processor systems.

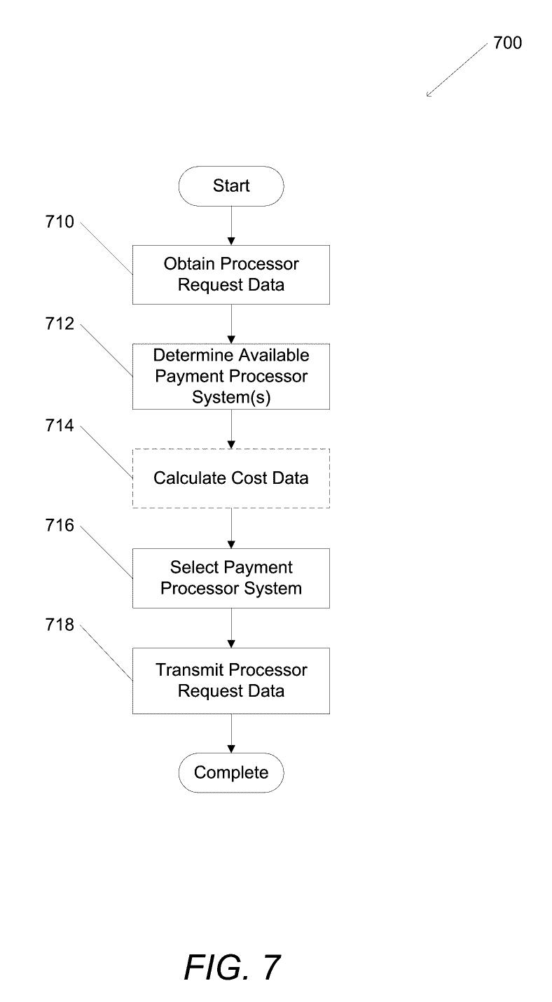

A process for selecting payment processor systems in accordance with embodiments of the invention is shown in FIG. 7. The process 700 includes obtaining (710) processor request data, determining (712) available payment processor systems, and in many embodiments calculating (714) cost data. Payment processor system(s) are selected (716) and processor request data is transmitted (718).

Specific process for selecting payment processors in accordance with embodiments of the invention are described above. However, any of a variety of processes, including those that utilize alternative factors not specifically described above, can be utilized as appropriate to the requirements of specific applications in accordance with embodiments of the invention.

### Incorporating Payment Processor Systems

One benefit of utilizing cached event feed data (i.e. an account transaction database) based on the processor request data and/or error data is that the services provided by an account servicing server system are isolated from the underlying banking platform (i.e. payment processor systems and/or financial institution systems) actually executing those services. In this way, account servicing server systems can easily incorporate new payment processor systems and/or migrate from one payment processor system to another. Migrating consumer accounts from one payment processor to a second payment processor can include obtaining processor account identification data from the second payment processor, updating the mapping data describing the mappings between the account identification data to reflect the new processor account identification data, and then transmitting processor request data to the second processor system.

Each payment processor system can have its own capabilities and commands that it can execute. Given processor capability data describing the processor account identification data and/or the processor commands that can be performed using the payment processor system, account servicing processes can include incorporating the payment processor system into the set of payment processor systems available to an account servicing server system. To incorporate a new payment processor system, the mapping data can updated as above, and new command mapping data between the existing command data and the processor command data for the payment processor system is generated. Any of a variety of command mappings, including those described above, can be utilized as appropriate to the requirements of specific applications of embodiments of the invention.

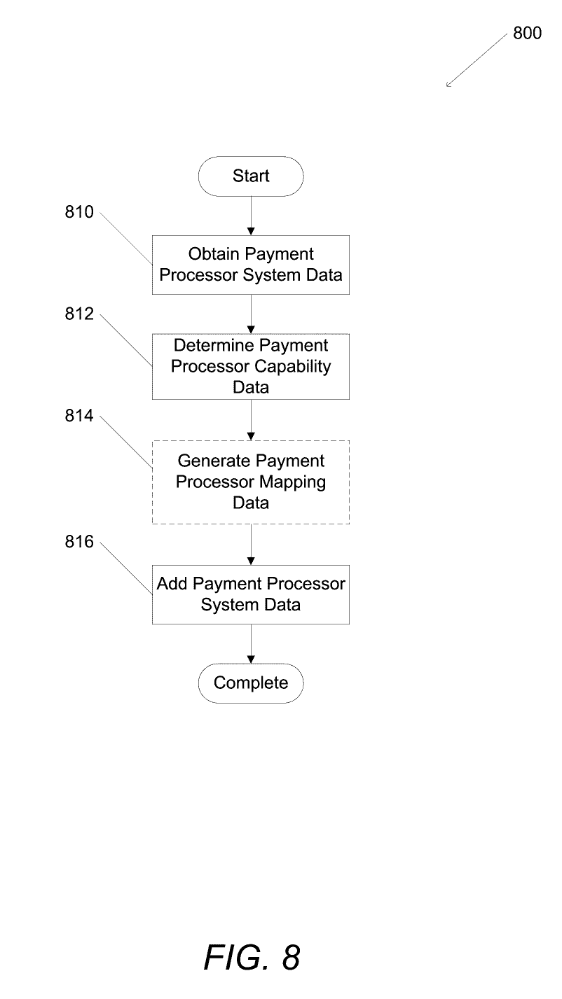

A process for incorporating a payment processor system in accordance with embodiments of the invention is shown in FIG. 8. The process 800 includes obtaining (810) payment processor system data, determining (812) payment processor capability data, and in several embodiments generating (814) payment processor mapping data. Payment processor system data is added (816).

Specific processes for incorporating payment processor systems in accordance with embodiments of the invention are described above. However, additional processes including those that create new command data to integrate additional payment processor system capabilities, can be utilized as appropriate to the requirements of specific applications in accordance with embodiments of the invention.

Although the present invention has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present invention can be practiced otherwise than specifically described without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A method for providing banking platform isolation, comprising:
obtaining account data using an account servicing server system, where the account data describes at least one consumer account;
obtaining event feed data using the account servicing server system, where the event feed data comprises a set of transaction data for at least one consumer account described in the account data;
generating an account transaction database for each consumer account based on the event feed data using the account servicing server system;
obtaining request data using the account servicing server system, where the request data comprises a request for a service for a consumer account;
generating response data based on the request data and the account transaction database using the account servicing server system; and
transmitting the response data using the account servicing server system.

2. The method of claim 1, wherein the event feed data is obtained from a payment processor system.

3. The method of claim 1, wherein the event feed data is obtained from a retailer system.

4. The method of claim 1, wherein the response data is transmitted to a client device associated with the consumer account.

5. The method of claim 1, wherein the transaction data comprises transaction amount data describing the requested value of the transaction and authorization data describing if the transaction was authorized.

6. The method of claim 5, further comprising:
calculating soft balance data for each consumer account based on the account transaction database using the account servicing server system;
identifying when a consumer account has a soft balance exceeding the amount specified in the requested amount data using the account servicing server system;
when the soft balance exceeds the requested amount data, generating processor request data comprising the request data and authorization data comprising approval data for the transaction using the account servicing server system; and
transmitting the processor request data using the account servicing server system.

7. The method of claim 6, wherein the processor request data is transmitted to a payment processor system.

8. The method of claim 5, further comprising placing a hold on a consumer account based on the transaction amount data.

9. The method of claim 8, wherein:
the event feed data further comprises post-transaction data; and
the method further comprises:
identifying a piece of transaction data corresponding to the post-transaction data using the account servicing server system; and
removing the hold on the consumer account based on the post-transaction data using the account servicing server system.

10. The method of claim 1, wherein:
the request data comprises a balance status request; and
the method further comprises:
calculating soft balance data for the consumer account based on the account data and the account transaction database using the account servicing server system; and
generating the response data based on the soft balance data.

11. The method of claim 1, further comprising:
generating processor request data based on the account data and the request data using the account servicing server system; and
transmitting the processor request data using the account servicing server system.

12. The method of claim 11, wherein the processor request data is transmitted to a payment processor system.

13. The method of claim 11, further comprising:
generating batch processor data using the account servicing server system, wherein the batch processor data comprises a set of processor request data; and
transmitting the batch processor data using the account servicing server system.

14. The method of claim 13, further comprising:
determining availability data for a payment processor system using the account servicing server system, wherein the availability data described when the payment processor system is available; and
transmitting the batch processor data when the payment processor is available based on the availability data using the account servicing server system.

15. The method of claim 11, wherein the processor request data comprises withdrawal request data.

16. The method of claim 11, wherein the processor request data comprises deposit request data.

17. The method of claim 11, further comprising obtaining error data comprising a set of transaction identification data and a set of validated event data using the account servicing server system.

18. The method of claim 17, further comprising:
identifying account transactions in the account transaction database based on the transaction identification data using the account servicing server system; and
correcting the account transactions based on the validated event data using the account servicing server system.

19. The method of claim 1, wherein:
the account data comprises account identification data;
each transaction in the event feed data comprises processor account identification data; and
the method further comprises:
mapping the processor account identification data to the account identification data using the account servicing server system;
updating the transaction data for each transaction described in the event feed data using the account servicing server system; and
generating the account transaction database based on the updated event feed data using the account servicing server system.

20. An account servicing server system, comprising:
a processor; and
a memory connected to the processor and storing an account servicing application;
wherein the account servicing application directs the processor to:
obtain account data, where the account data describes at least one consumer account;
obtain event feed data, where the event feed data comprises a set of transaction data for at least one consumer account described in the account data;
generate an account transaction database for each consumer account based on the event feed data;
obtain request data, where the request data comprises a request for a service for a consumer account;
generate response data based on the request data and the account transaction database; and
transmit the response data.
